(19) United States
(12) Patent Application Publication
(10) Pub. No.: US 2014/0084810 A1
(43) Pub. Date: Mar. 27, 2014

(54) ILLUMINATION CIRCUIT FOR A TIME-OF-FLIGHT CAMERA

(71) Applicant: PMDTECHNOLOGIES GMBH, Siegen (DE)

(72) Inventors: Holger Bette, Lennestadt (DE); Ralf-Martin Kramer, Wetzlar (DE)

(73) Assignee: PMDTECHNOLOGIES GMBH, Siegen (DE)

(21) Appl. No.: 13/627,090

(22) Filed: Sep. 26, 2012

(51) Int. Cl. H05B 37/02

(52) U.S. Cl. 315/294

(57) ABSTRACT

An illumination circuit for a time-of-flight camera includes at least one light source. At least one switch is configured to influence the at least one light source. At least one current limiter is disposed in a current path of the at least one light source. A parallel capacitor is disposed parallel to the at least one current limiter. The at least one light source can include a light-emitting diode and the at least one current limiter can include at least one of a limiting resistor, a limiting switch and limiting diode.

### FIELD

The invention relates to an illumination circuit for a time-of-flight camera.

### BACKGROUND

Systems for three-dimensional image acquisition can function by making use of active illumination. These include so-called time-of-flight (TOF) or propagation-time measuring systems. Such systems use amplitude-modulated or pulsed illumination to illuminate the three-dimensional scenery that is to be acquired.

The terms time-of-flight measuring system or time-of-flight camera include especially all three-dimensional camera systems that acquire time-of-flight information from the phase shift of emitted and received radiation. In particular, so-called Photonic Mixer Devices (PMD) are suitable as a 3D camera or a PMD camera of the type described in German patent document DE 196 35 932, European document EP 1 777 747, U.S. Pat. No. 6,587,186 and also German document DE 197 04 496, and available, for instance, as a 3D camera from the company IFM ELECTRONIC GMBH.

### SUMMARY

In an embodiment, the present invention provides an illumination circuit for a time-of-flight camera. The illumination circuit includes at least one light source. At least one switch is configured to influence the at least one light source. At least one current limiter is disposed in a current path of the at least one light source. A parallel capacitor is disposed parallel to the at least one current limiter. The at least one light source can include a light-emitting diode and the at least one current limiter can include at least one of a limiting resistor, a limiting switch and limiting diode.

### BRIEF DESCRIPTION OF THE DRAWINGS

The present invention will be described in even greater detail below based on the exemplary, schematic figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically shows a measuring scenario for an optical distance measurement with a time-of-flight camera;

FIGS. 2-30 and 30a-30e schematically show illumination circuits according to embodiments of the invention; and

FIG. 31 schematically shows a current curve in the current path of the light sources according to an embodiment of the invention.

### DETAILED DESCRIPTION

The precision and reliability of the distance measurement in a time-of-flight measurement system depends, among other things, on the quality of the receiver and of the light source. When a high luminous energy is employed, especially large distances can be included in the distance measurement. The quality of the light modulation also influences the precision of the distance measurement.

Advantageously, an illumination circuit for a time-of-flight camera is provided having at least one light source, preferably a light-emitting diode, and at least one switch for influencing the light source. In the current path of the light source, there is at least one current limiter and a parallel capacitor arranged in parallel to it. The current limiter can especially be configured as a limiting resistor, a limiting switch and/or a limiting diode. The parallel arrangement, along with the current limiter, has the advantage that, during the switch-on procedure, the current limiter is briefly bridged via the capacitor and a steeper rising edge can be achieved. During the switch-off procedure, the switch-off time is shortened by means of the same effect. Due to the steeper trailing and leading edges thus achieved, the modulation frequency can be advantageously increased, which leads to an improvement in the measuring precision. Equally advantageously, the range can be increased or the measuring duration can be shortened while the measuring precision remains constant.

Preferably, the current limiter supplies a resistance in the range from 0.5 ohm to 20 ohm, and the parallel capacitor supplies a capacitance in the range from 100 pF to 10 nF.

In another embodiment, the current limiter and the parallel capacitor that is arranged in parallel form an impedance element, whereby several impedance elements are arranged in the current path of the light source. This especially has the advantage that the power losses can be distributed over several modules and the individual impedance element modules can be configured to be smaller.

Advantageously, in an embodiment having several light sources, an impedance element is arranged between each of the light sources.

Moreover, the current limiter of the impedance element is advantageously configured as a switch or as a Zener diode, or else as a combination of a switch and a Zener diode.

In another embodiment, the light source is configured or selected in such a way that an internal resistance of the light source and a capacitance of the light source, especially a parasitic capacitance, lie in a range from 0.5 ohm to 20 ohm as well as in a range from 100 pF to 10 nF.

In the description of the exemplary embodiments below, the same reference numerals refer to identical or comparable components.

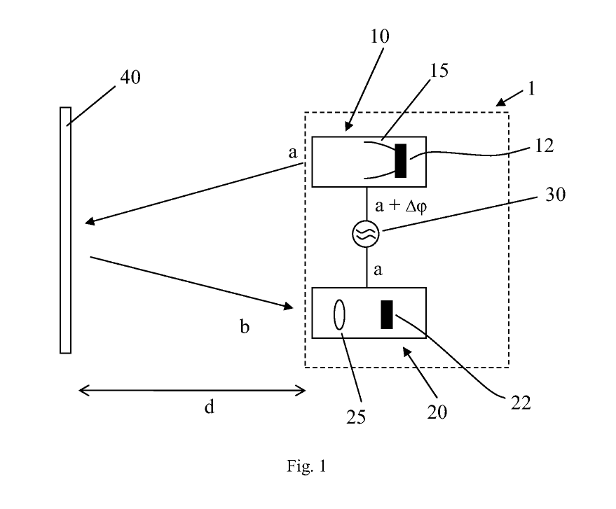

FIG. 1 shows a measuring scenario for an optical distance measurement with a time-of-flight camera of the type known, for example, from German document DE 197 04 496.

The time-of-flight camera or the time-of-flight camera system 1 comprises a transmitting unit or an illumination module 10 with an illumination light source 12 and an associated beam-forming lens 15 as well as a receiving unit or TOF camera 20 with a receiving lens 25 and a time-of-flight sensor 22. The time-of-flight sensor 22 has at least one pixel, but preferably a pixel array, and is especially configured as a PMD sensor. In order to improve the imaging properties, the receiving lens 25 typically consists of several optical elements. The beam-forming lens 15 of the transmitting unit 10 is preferably configured as a reflector or as a combination of reflective and refractive elements.

The measuring principle of this arrangement is essentially based on the fact that the time-of-flight of the emitted and reflected light can be determined from the phase shift of the emitted and received light. For this purpose, a first phase angle a is applied jointly to the light source 12 and to the time-of-flight sensor 22 via a modulator 30 with a certain modulation frequency. Corresponding to the modulation frequency, the light source 12 emits an amplitude-modulated signal with the phase a. In the case shown here, this signal or the electromagnetic radiation is reflected off an object 40 and, due to the traversed distance, strikes the time-of-flight sensor 22 correspondingly phase-shifted with a second phase angle b. In the time-of-flight sensor 22, the signal of the first phase angle a of the modulator 30 is mixed with the received signal that has the second, time-of-flight-related, phase angle b, whereby the phase shift or the object distance d is ascertained from the resulting signal.

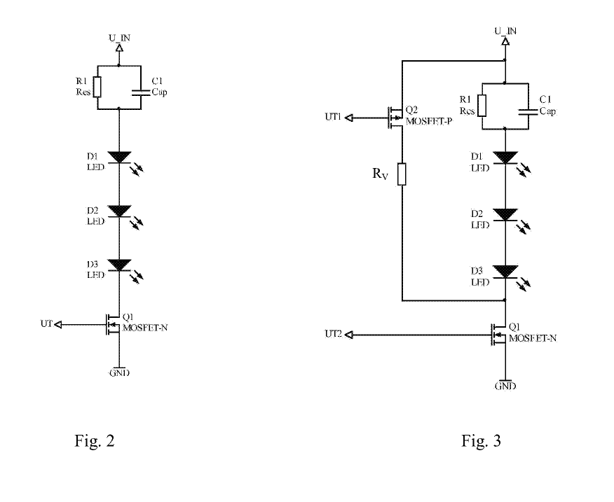

FIG. 2 shows an illumination circuit according to an embodiment of the invention with three light-emitting diodes D1, D2, D3 and with a switch Q1 that is configured here as a MOSFET. The three light-emitting diodes are connected in series, whereby the cathode of the third light-emitting diode D3 is connected to the reference potential GND so as to be switchable via the switch Q1. The anode of the first light-emitting diode D1 is connected to the supply voltage U_IN via a limiting resistor R1. A parallel capacitor C1 according to an embodiment of the invention is arranged parallel to the limiting resistor R1. The gate-side of the switch Q1 configured as a MOSFET is connected to a switching potential UT.

In the clock pulse of the desired modulation frequency, the switch Q1 is opened and closed, which correspondingly modulates the current flow through the light-emitting diodes, which then naturally emit a correspondingly modulated light signal.

Aside from the limiting resistor, there is no capacitor in a conventional illumination circuit, so that when the light-emitting diodes are switched on and off, the current is limited by the limiting resistor R1, and this leads to a flattening of the leading and trailing edges. In order to achieve the best possible measurement results, however, it is desirable to attain the highest possible contrast and the lowest possible switching times.

For purposes of shortening the switch-on times and in order to be able to achieve high modulation frequencies, it is provided according to an embodiment of the invention that the work is carried out with a voltage or current overshoot at the light sources. Towards this end, it is provided for a parallel capacitor C1 to be arranged parallel to the limiting resistor R1. At the switch-on moment, the limiting resistor is bridged due to the capacitor that is connected in parallel.

This circuitry is especially effective with light sources that respond to high currents with considerable switching time shortening.

The circuitry can also be used for other circuit concepts. In particular, the parallel capacitor according to an embodiment of the invention can be arranged not only parallel to a resistor element, but also parallel to other elements that are associated with a voltage drop. Here, depending on the direction of the current flow, the voltage drop through the component can also be different as is the case, for example, with Zener diodes.

Depending on the type of light source, which can be implemented in parallel and/or series connections, the parallel-connected capacitor C1 can be adapted accordingly. The parameters here are the capacitance and the dielectric of the capacitor.

Depending on the application purpose, the supply voltage U_IN, the limiting resistor R1 and the parallel capacitor C1 can be coordinated with each other in order to achieve optical rising and falling times that are as short as possible or that meet the requirements of the application. Preferable times are in a range that is smaller than ¼ of the period and it is especially better for them to be ⅙ of the period.

Advantageously, the limiting resistances here are preferably in the range from 0.5 ohm to 20 ohm, and the parallel capacitors preferably have a capacitance in the range from 100 pF to 10 nF.

Instead of the switch that is configured as a MOSFET, one can, of course, use other switches such as, for instance, bipolar transistors, IGBTs, electron tubes, optocouplers, phototransistors, etc. Moreover, the light source is, of course, not restricted to the described light-emitting diode; for example, it is also possible to use RCLED, superluminescence diodes, laser diodes, edge-emitting lasers (EEL), vertical-cavity surface-emitting lasers (VCSEL), organic light-emitting diodes (OLED), and also light-emitting diodes with wavelength shifters.

Moreover, the capacitor does not have to be explicitly configured as a capacitor element, but can also be replaced by an element with a similar or identical effect. For example, it is also conceivable to utilize parasitic capacitors of components, for example, of a diode or else a light-emitting diode for this purpose. Furthermore, the supply voltage source can also consist of several sources.

FIG. 3 shows another embodiment in which a second switch Q2 with a starting resistor R, is arranged in parallel to the light-emitting diodes and to the limiting resistor. This second switch Q2 serves for the commutation or acceleration of the switch-off procedure of the optical signal (falling edge).

When the device is switched off, a so-called current commutation becomes active, that is to say, the point of the illumination that had previously been connected to the reference potential GND is not connected in terms of its potential to the supply voltage U_IN. In addition, the parallel capacitor C1 employed according to an embodiment of the invention is also active here since, also at the switch-off moment, the resistor to the current limiter is bridged by this capacitor.

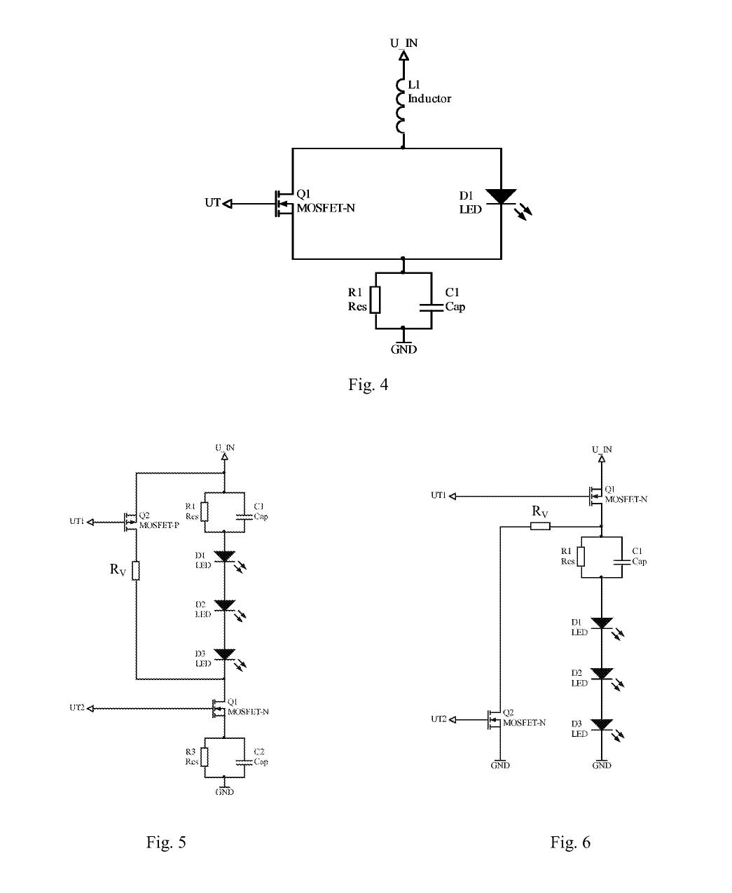

FIG. 4 shows an arrangement in which the impedance element according to an embodiment of the invention is arranged on the cathode side of the light source or light-emitting diode D1, whereby the light-emitting diode is modulated via a switch Q1 arranged in parallel to the light-emitting diode, and whereby energy and is buffered via an inductor L1 arranged on the anode side.

When the illumination is in the switched-off state, that is to say, when the switch Q1 is closed, the inductor L1 is connected to the reference potential GND and thus ‘charged’. The applied voltage is typically smaller than the forward voltage of the light sources D1.

When the switch Q1 is opened, the current is maintained due to the energy stored in the B-field of the inductor L1 and it is now conducted through the light source D1 situated parallel to the switch Q1.

Very short switch-on times can be achieved with this approach. Without the impedance element according to an embodiment of the invention, however, the switch-off times would be lengthened because of the resistance induced by the inductor and the consequently higher power requirement. A standard circuit without the impedance element according to an embodiment of the invention would thus be limited to low modulation frequencies.

FIG. 5 essentially corresponds to FIG. 3, except that in contrast to FIG. 3, another impedance element according to an embodiment of the invention is arranged on the source side of the MOSFET.

In FIG. 6, in contrast to FIG. 3, the first switch Q1 does not separate the light sources D1, D2, D3 from the reference potential GND but rather from the supply voltage U_IN. A second switch Q2, together with a starting resistor Rᵥ, is arranged in parallel to the light sources D1, D2, D3, whereby the source-side of the second switch Q2 is connected to the reference potential GND.

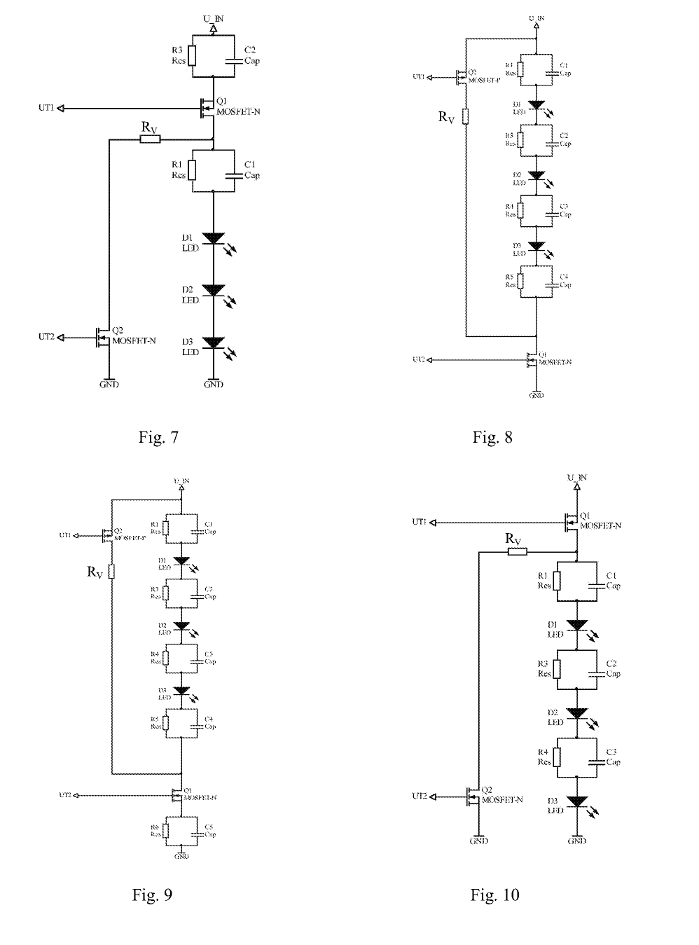

In FIG. 7, in addition to the circuit shown in FIG. 6, another impedance element according to an embodiment of the invention is arranged between the drain-side of the first switch Q1 and the supply voltage U_IN.

FIG. 8 corresponds to the circuit shown in FIG. 3, except that in addition to the first impedance element, consisting of the first limiting resistor R1 and the parallel capacitor C1, another impedance element according to an embodiment of the invention is arranged on the cathode side of each of the light-emitting diodes D1, D2, D3.

In FIG. 9, in addition to the circuit shown in FIG. 8, another impedance element is arranged on the source-side of the first switch Q1.

FIG. 10 corresponds to the circuit according to FIG. 6, except that in each case here, an impedance element according to an embodiment of the invention is arranged on the cathode side of the light-emitting diodes D1, D2, D3.

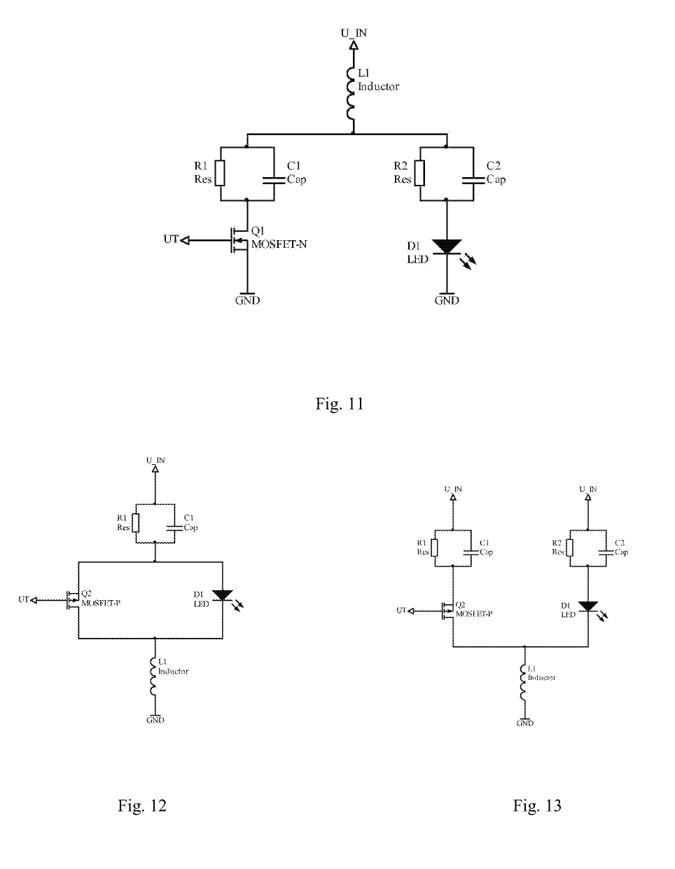

FIGS. 11 to 13 show essentially a circuit according to FIG. 4, whereby one or more impedance elements according to an embodiment of the invention are arranged in different positions in the circuit.

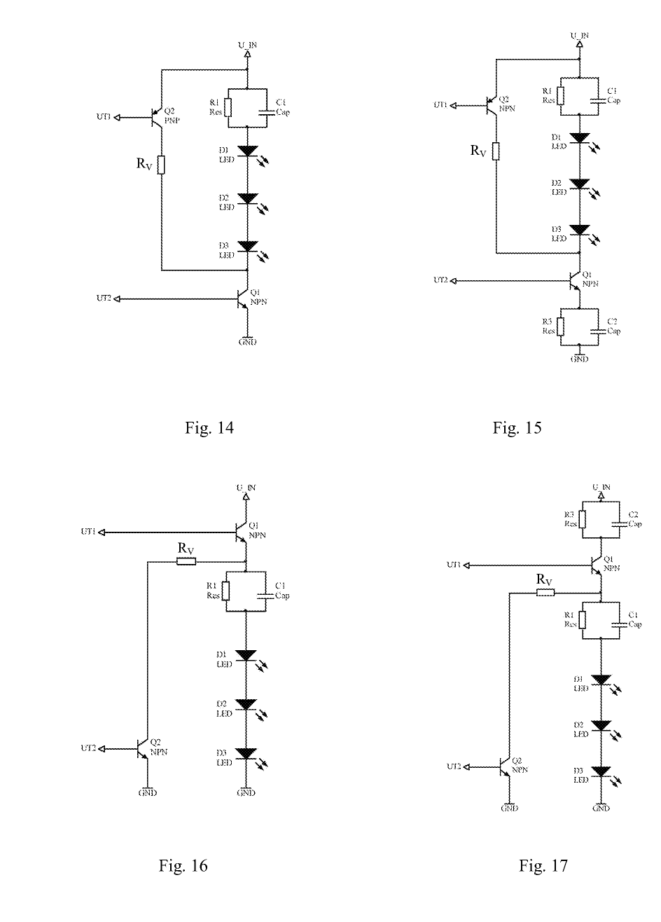

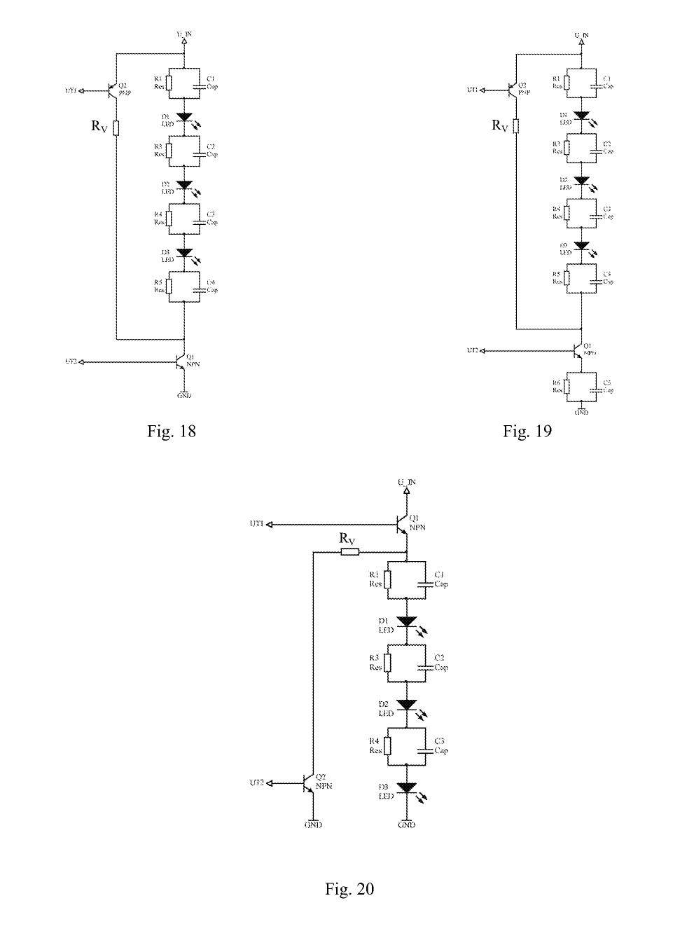

FIGS. 14 to 20 essentially match FIGS. 2, 3 as well as 5 to 10, whereby in contrast to the cited figures, the switches Q1, Q2 are replaced by a transistor.

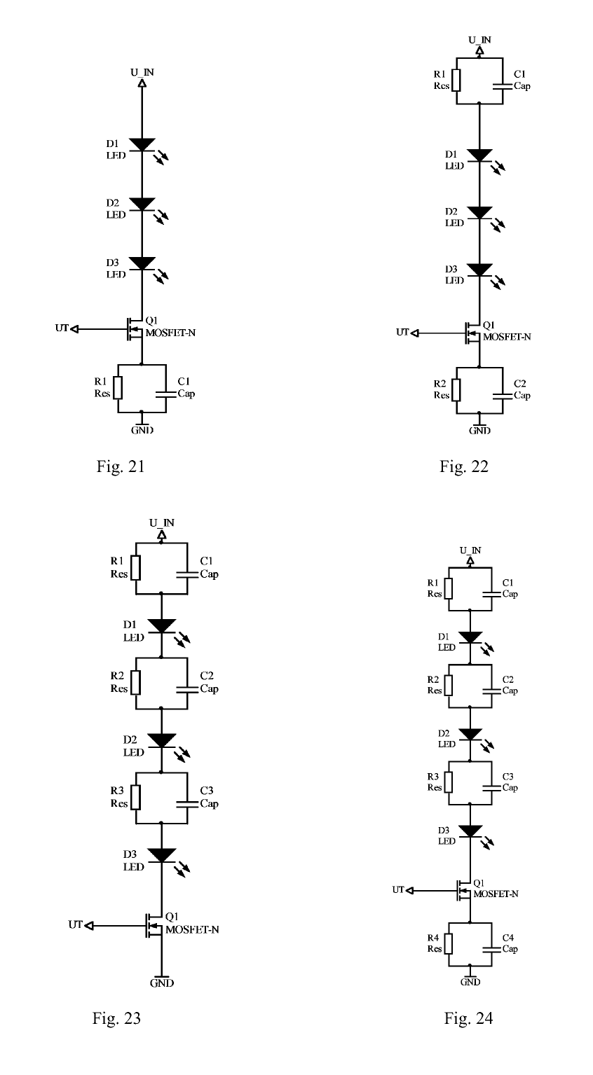

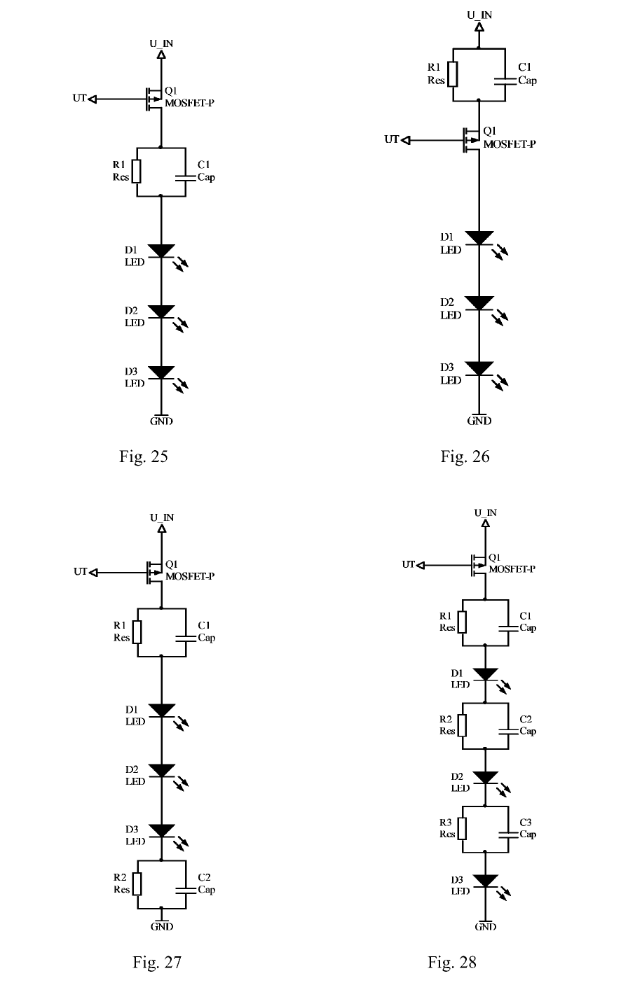

FIGS. 21 to 28 show additional variants of the principle according to an embodiment the invention.

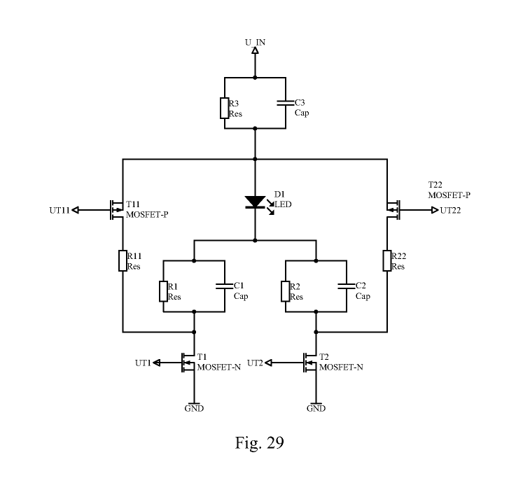

FIG. 29 shows a variant in which a light-emitting diode D1 can optionally be switched via two, for example, also several impedance elements. The cathode of the light-emitting diode D1 is connected to a first impedance element consisting of a first limiting resistor R1 and a first parallel capacitor C1 as well as to a second impedance element consisting of a second limiting resistor R2 and a second parallel capacitor C2. Optionally, the cathode of the light-emitting diode can be connected to the reference potential GND via the first or second impedance element, each time via a first and/or second switch T1, T2. Moreover, parallel to the light-emitting diode and the first and second impedance elements, there is a first and second current commutation path, each consisting of a third or fourth switch T11, T22 as well as of a first or second starting resistor R11, R22. The anode of the light-emitting diode D1 can be connected to the drain terminal of the first or second switch T1, T2 via the first or second current commutation path.

This set-up has a number of advantages. First of all, the symmetrical circuit set-up allows the total current in the light sources to be increased and the power can be controlled when the branches are connected individually, and secondly, the possibility exists to provide the current paths with different electric properties, so that different switching properties can be implemented by switching over between the current paths.

Thus, for example, it can be provided that the one current path is optimized due to the selected electric parameters for short switching times, whereas the other current path is optimized for another switching or modulation frequency.

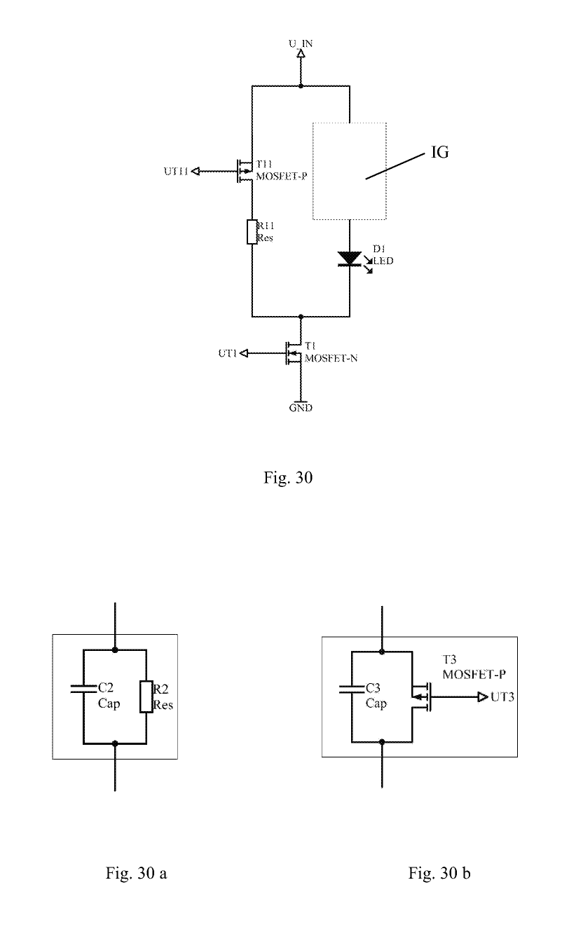

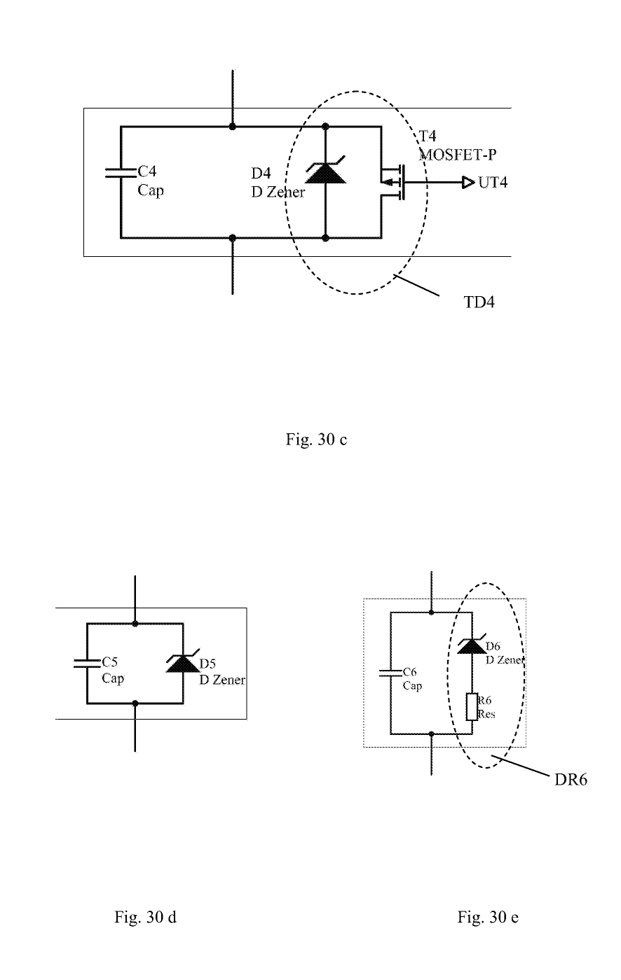

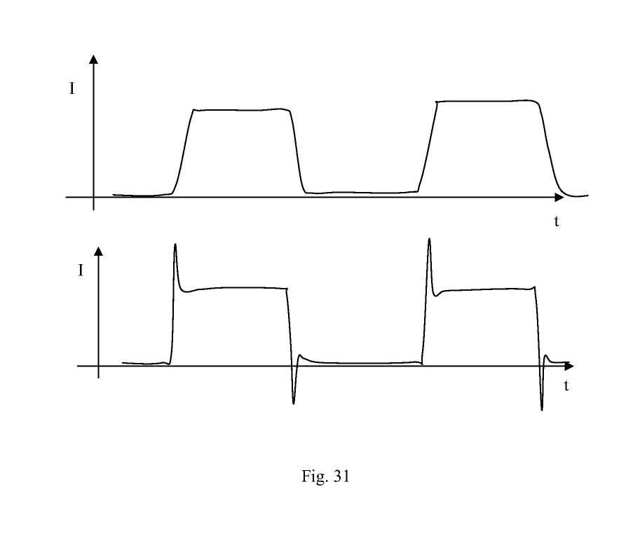

FIG. 30 shows by way of example a schematic representation of the circuit according to an embodiment of the invention with a light-emitting diode D1. In FIG. 30, the impedance element IG is not shown with individual components but rather constitutes a functional component with ohmic and capacitive properties according to an embodiment of the invention.

A switch T11 and a starting resistor R11 are arranged in parallel to the impedance element IG and the light-emitting diode D1. The cathode of the light-emitting diode D1 is connected to the reference potential GND via the switch T1.

The subsequent FIGS. 30a to 30e show possible variants of the impedance element (IG) according to an embodiment of the invention.

FIG. 30a shows the impedance element described so far with a parallel-connected limiting resistor R2 and a parallel capacitor C2.

In FIG. 30b, the limiting resistor R2 shown in FIG. 30a has been replaced by a switch T3, for example, a MOSFET, having the same effect. The switch T3 is preferably connected to a control unit that, in turn, actuates the switch T3, for instance, as a function of an electric value, preferably a current. This actuation can be carried out, for example, in the form of a DC signal in order to influence the current through the light sources and thus the light intensity, or for instance, in the form of an AC signal in order to apply an overmodulation onto the basic signal. Thus, the switch T3 provides an electric behavior that corresponds to an ohmic resistance in accordance with the above-mentioned examples.

FIG. 30c shows another variant in which additionally a Zener diode D4 is connected in parallel to the switch T4. Parallel to the switch T4, the Zener diode D4 adds a non-linear ohmic resistance. This arrangement has the special advantage that the preferably current-regulated or current-controlled transistor can be bridged for a preferred current direction or preferred voltage (Zener voltage).

FIG. 30d shows a version that is simplified in comparison to the variant in FIG. 30c, in which the current-limiting element is achieved only by the Zener diode D5.

In FIG. 30e, there is a starting resistor R6 in addition to the non-linear Zener diode D6.

In another example, it is provided to configure or select the light source itself in such a way that the resistance as well as the capacitance of the light source are in a range from 0.5 ohm to 20 ohm or in a range from 100 pF to 10 nF.

FIG. 31 shows a schematic representation of a possible current curve in the current path of the light sources. The upper curve shows a current curve without the impedance element according to an embodiment of the invention while the lower curve is shown with an impedance element. Without the impedance element, a flat rise and fall in the current curve can be seen when the light source is switched on and off, whereas with the approach according to an embodiment of the invention, the current rises steeply with a small current overshoot and falls correspondingly. The current overshoot is dimensioned to be such that it is not harmful for the entire circuit.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

What is claimed is:

1. An illumination circuit for a time-of-flight camera, comprising:
at least one light source;
at least one switch configured to influence the at least one light source;
at least one current limiter disposed in a current path of the at least one light source; and
a parallel capacitor disposed parallel to the at least one current limiter.

2. The illumination circuit according to claim 1, wherein the at least one light source includes a light-emitting diode.

3. The illumination circuit according to claim 1, wherein the at least one current limiter includes at least one of a limiting resistor, a limiting switch and limiting diode.

4. The illumination circuit according to claim 1, wherein the at least one current limiter is configured to supply a resistance in a range from 0.5 ohm to 20 ohm, and the parallel capacitor is configured to supply a capacitance in a range from 100 pF to 10 nF.

5. The illumination circuit according to claim 4, wherein the at least one current limiter and the parallel capacitor together form an impedance element, the illumination circuit further comprising a plurality of the impedance elements disposed in the current path of the at least one light source.

6. The illumination circuit according to claim 5, wherein the at least one light source includes a plurality of light sources, a respective one of the impedance elements being disposed between each of the light sources.

7. The illumination circuit according to claim 1, wherein the at least one current limiter of the impedance element is configured as a switch, as a Zener diode, or as a combination thereof.

8. The illumination circuit according to claim 1, wherein the at least one light source has an internal resistance in a range from 0.5 ohm to 20 ohm and a capacitance in a range from 100 pF to 10 nF.

9. The illumination circuit according to claim 8, wherein the capacitance is a parasitic capacitance of the at least one light source.
